(19) United States
(12) Patent Application Publication
(10) Pub. No.: US 2026/0252331 A1
(43) Pub. Date: Aug. 27, 2026

(54) RANK-BASED APPLICATION DEPLOYMENT

(71) Applicant: Hewlett Packard Enterprise Development LP, Spring, TX (US)

(72) Inventors: Pavan Kumar Challapalli, Bangalore (IN); Naveen Kondiparti, Bangalore (IN)

(21) Appl. No.: 19/231,636

(22) Filed: Jun. 9, 2025

(30) Foreign Application Priority Data
Feb. 27, 2025 (IN) 202541017670

(51) Int. Cl. G06F 8/60; G06F 8/41

(52) U.S. Cl. CPC G06F 8/60; G06F 8/433

(57) ABSTRACT

A development environment for managing application automatic deployment for updated modules for applications that may have a large number of modules asynchronously updated by developers that may have limited insight to other developer activity or to the overall scope of the application being deployed. Continuous Integration/Deployment (CI/CD) tools may be used to identify updates to modules. The CI/CD tools cooperatively operate with graphing tools that track module interdependencies and deployment target relevance, and a module registry to facilitate ranking module deployment order to ensure a deployment order satisfying the module deployment dependencies and deployment target relevance.

### BACKGROUND

Automating the distribution of updates to large, multi-component applications, e.g. modules, is crucial for maintaining agility and minimizing downtime. Continuous Integration/Continuous Delivery (CI/CD) pipelines may be used to assist a manual process from code commit to production deployment. For applications comprising many components, a robust CI/CD pipeline is an important aspect of application deployment because it helps provide consistency and reliability. The automation foundation lies in a version control system, where each component resides in storage, such as a repository or within a local storage which may be monorepo. Developers commit changes to their respective modules, triggering the CI process. After passing the CI process, the other part of the pipeline, Continuous Delivery, then focuses on automating the release and deployment of the updated components.

Application deployment teams determine updated modules that are ready for deployment, and filter them against a desired deployment target, such as a particular platform or service into which the application is to be provided. The filtered modules are then manually reviewed to identify a deployment order that does not break any dependencies known to exist between the modules of the application. The modules are then appropriately deployed.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1A illustrates an exemplary system for storing instructions to direct the system to deploy an application and/or associated data in accordance with various example implementations.

FIG. 1B illustrates an exemplary method in accordance with the FIG. 1A example implementation.

FIG. 2 illustrates, according to one example implementation, a directed acyclic graph.

FIG. 3 illustrates, according to one example implementation, a directed acyclic graph.

FIG. 4 illustrates, according to one example implementation, a directed acyclic graph.

FIG. 5 illustrates an exemplary cloud-based system for deploying an application and/or associated data in accordance with various example implementations.

FIG. 6 illustrates an exemplary computing device.

FIG. 7 illustrates an exemplary computer-readable storage medium.

### DESCRIPTION

The following disclosure provides many different examples for implementing different features. Specific examples of components and arrangements are described below to simplify the present disclosure. These are, of course, merely examples and are not intended to be limiting.

Certain implementations of this disclosure relate to managing application deployment. In some scenarios, the application may be a large cloud application or product that is a construct from hundreds of modules, and the modules may contain microservices, such as User Management, Frontend, Backend, Functions, Services, Data Access/Retrieval, etc. In some implementations, the modules of a cloud application could be more specific to a specific target environment such as Azure, AWS, etc. ; however, the disclosure contemplates managing multiple applications/microservices/etc. The term “module” will be used to generally refer to data provided by a developer, such as code for a microservice, or any data, meta-data, files, etc. that may be associated with the microservice. The term “application” will be used to refer to the overall application being deployed based one or more of the modules. Since there can be many target deployment environments, a particular deployment of an application will include some or all of modules associated with the application.

When a developer updates code associated with a module, a CI server or CI tool, such as Jenkins, GitLab CI, GitHub Actions, or the like, detects the code change and initiates the build process. For each modified module, the pipeline compiles the code, runs unit tests, and packages the component into a deployable artifact (e.g., a JAR file, Docker image, zip archive, etc.). As will be discussed in detail below, dependencies between modules are carefully managed during this stage, ensuring compatibility and preventing conflicts. The CI tool may incorporate integration and system tests to verify an updated module interacts correctly with other components and that the overall application functionality remains intact. For large applications, this may involve setting up a staging environment that mirrors a production environment. Automated test frameworks, like Selenium, Junit, or the like, may facilitate these tests.

Once build and testing stages are successful, deployable artifacts may be stored in an artifact repository, such as Nexus or Artifactory. A repository may act as a hub for build artifacts, and provide version control and facilitate rollback. In one example implementation, artifacts are stored separately to ensure deployments are reproducible and previous versions can be retrieved. Multiple possibly-independent developers may be contributing modules for one or more target environments, where modules may have dependencies, such as it relies on and/or incorporates other modules, microservices, apps, data, etc. Since microservice developers can be unrelated, they may lack global knowledge about all microservices and hence they might not be able to do more than indicate their own particular dependencies and requirements. A deployment tool may track module updates for multiple target environments, and facilitate automatically deploying modules for a particular target environment in a particular deployment order to satisfy dependency requirements. Automating deployment is important when an application has a large number of modules rendering conventional manual deployment impractical. Note as used herein the term “environment” may be used in reference to one or more tool, which may also include any associated data, performing a function or task; for example, a “deployment environment” may refer to use of tools, and their associated data, to deploy modules for an application.

For clarity in presentation, the following will attempt to abstract from specific implementation environments. As an exemplary context, the reader is expected to be familiar with containerization environments such as Docker, which is an open platform for developing, shipping and running applications. It will be appreciated this and other environments may be used to separate applications from infrastructure and allow them to be separately managed, updated, tested, and deployed. Assuming familiarity with Docker, there may be an associated Dockerfile, which is data, such as a text file, that contains commands and/or instructions needed to assemble a Docker image. There may be YAML (Yet Another Markup Language) files, such as Kubernetes YAML files, to describe an application's services, networks, and volumes. These may be used to define, as understood by one skilled in the art, container images that would be published to a container registry, such as DockerHub or the like. A container may contain developer code, e.g., the source code for modules in an application, and there may be data associated with a module, such as application and/or module dependency information, or meta data. The container may also contain metadata associated with the code, such as data relating to interrelationships between modules that may be used to, for example, graph module relationships as discussed in detail below.

The Docker or equivalent data and developer code and associated data may be stored in a repository, such as a Git or GitLab repository. It will be appreciated any storage environment or repository system may be used, and Git-based environments, e.g., GitLab, are presented as they are well-known development environments. It will be appreciated in exemplary implementations, data may be stored in various combinations of containers, registries, or other storage environments. For example, a container image may contain developer's code and the container stored in a registry or repository such as DockerHub; a Kubernetes Artifact for an Orchestration Definition(s) may be stored in Helm Artifactory or Git-based environments; and module metadata (e.g., module interdependency data that may be used to graph/relate modules to each other) may be stored in a custom defined “metadata registry”. Also, while these are presented as being stored in separate data storages, e.g., registries, repositories, or the like, some or all of these may be stored in fewer or more data storages as desired.

In the illustrated example implementations, it is assumed the reader is familiar with CI/CD (Continuous Integration/Continuous Deployment), and how CI/CD engages a repository, such as a Git repository, to automate the integration of a developer's code changes for a module into the codebase for an application. It will be appreciated there are many different CI/CD implementations, such as with ArgoCD, Azure Devops Server, Bamboo, CircleCI, Git, GitLab, Jenkins, Semaphore, TeamCity, just to name a few. One aspect of CI, as applied to the illustrated example implementations, is it can automatically identify a change to developer code, run build tools, generate artifacts, run tests and/or validate updated code, and push artifacts to registries/repositories. Another aspect of CI/CD tools, as applied to the illustrated example implementations, is it can automatically and continuously integrate the updated code into the application and ensure the application is always ready for release. And as discussed above, the application may be targeted to multiple different target environments, such as AWS, Azure, etc., and the CI/CD will be used to appropriately prepare updated modules to provide a releasable application for the desired target.

Developers may be working with limited information and hence may be unaware of the larger scope in which their module(s) operate, and unaware of the target environment in which an application may be intended to be deployed. A developer may be tasked with writing “black box” code only knowing data going into their module, and data output expected from their module. The developer may know dependencies on which their module relies, e.g., a module may rely on their own or other developer modules, other applications, files, local and/or networked resources, etc. A large application may have thousands of modules, and interdependencies between modules becomes very complex. Developers may asynchronously update their module.

The CD portion of the CI/CD pipeline focuses on automating the release and deployment of the updated modules. This can involve multiple stages, such as Staging Deployment to test for final integration testing before releasing to production, as well as other testing stages such as Canary Deployment, Blue/Green Deployment, and Production Deployment, where updated modules have been thoroughly tested by the CI and/or in staging testing, and they are deployed to the full production environment. However, managing module interdependencies and module configurations across many modules and associated data can be a significant challenge. To facilitate automated deployment, developers identify dependencies for their modules.

Identified dependencies may be used to create a relationship Directed Acyclic Graph (DAG) showing the interdependencies between modules and other data associated with an application. The DAG may be stored in one or more databases. For example, a GraphDB graph database that can integrate with many search tools may be used; however, it will be appreciated another graph database may be used. For expository convenience, assume use of well-known tools such as Git/GitLabs, GraphDB, and CI/CD tools such as noted above, or ArgoCD and Kubernetes. Thus, when modules are updated, in various example implementations, the CI tests updated modules to ensure they are operating correctly. Correct updated modules are marked as deployable. There may be deployment criteria, such as a specific target environment as noted above. In some example implementations, the CD then queries the graph database for a DAG identifying deployable modules that meet that deployment criteria.

In illustrated example implementations, rather than performing a manual deployment process, instead a DAG may be filtered based on desired characteristics, such as intended deployment environment, e.g. AWS, Azure, etc. which may adjust the modules deemed relevant to a specific deployment. The DAG may be analyzed to rank identified updated modules into a ranking order for performing the integration. Modules on which another module depends would have a higher ranking and as such would be processed before the module depending on it. This ensures that for an updated module, higher-ranking modules have been processed, e.g., compiled, tested, integrated, deployed, etc., before performing such operations on the lower-ranking updated module. With ranking, deployment may automatically be performed since ranking resolves ambiguity in the interdependencies of updated modules. It will be appreciated modules having the same rank may be deployed in parallel and/or in arbitrary order since they do not depend on each other.

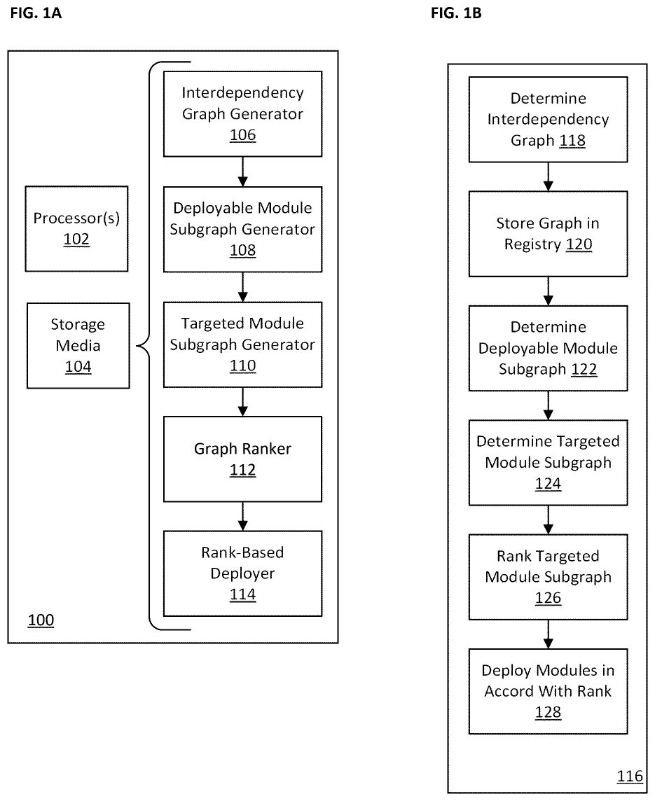

FIG. 1A illustrates an exemplary system for storing instructions to direct the system to deploy an application and/or associated data in accordance with various example implementations.

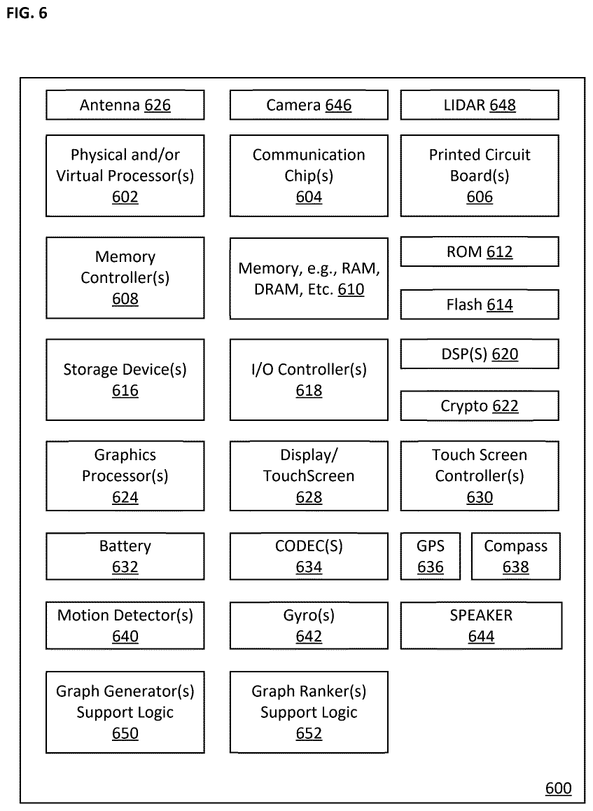

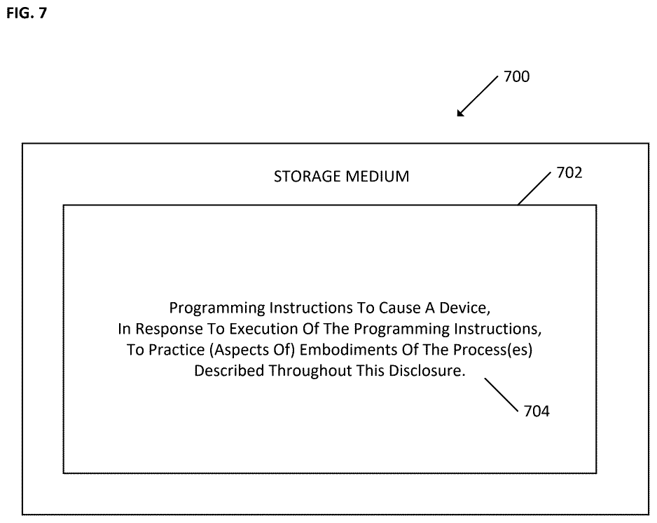

To perform deployments, in various example implementations the exemplary illustrated system 100 may be used. The system may include, for example, one or more processor 102 that operates in conjunction with storage media 104. The processor and storage media will not be described in particular detail here but attention is directed to the discussion for FIGS. 6, 7 for a more detailed of various example implementations including processors and storage media. In this example implementation, the storage media may store instructions, program code, directives for a computing device, or other data that has the effect of directing the processor(s) to perform deployment-related tasks such as in conjunction with CI/CD services discussed above.

As illustrated the storage media 104 may store instructions for a graph generator 106, such as to build an interdependency graph corresponding to modules for an application. For example, assume the application is a network-accessible program, e.g., accessible over a network by a web browser, another application, a module, by an app on a mobile device, etc. In one example implementation the graph generator is based at least in part on the GraphDB platform, however other graphing solutions may be used. In one example implementation, an application code repository may store docker files, YAML files, developer module code, and dependency information for the module code, as well as any other data/metadata associated with a module. As discussed above, changes to a module may be identified by a CI/CD process, resulting in generating artifacts for the docker and YAML data such as docker images, Kubernetes artifacts, e.g., Helm artifacts may be used, and an application metadata artifact may be generated for developer code and other data, which in one example implementation is pushed to an artifactory called AppMeta Registry. It will be appreciated “AppMeta Registry” is an arbitrary name for a registry that provides features and functionality such as described below.

The application metadata artifact includes information needed to assist with the deployment of an application into a desired target environment, and has a structure/schema derived at least in part from the developer identified dependency information. The dependency information includes identifying deployment dependencies between a module and other applications and/or modules. The dependency information may also include labels that can be tagged to the application and/or module, and are a resource to facilitate filtering such as for deployment to a specific target, e.g., performing a first deployment for AWS, a second deployment for Azure, etc. where the labels/tags allow ensuring only target-relevant applications and/or modules are used.

The graph generator 106 is assumed to be functionality provided by the AppMeta Registry, and the registry, in one example implementation, is a server that stores at least the application metadata, which includes the dependency information. The graph generator can access, e.g., receive or retrieve, the dependency information and process it to create a directed acyclic graph (DAG) corresponding to the dependency information. It will be appreciated an application may have hundreds if not thousands of modules and other associated applications, and the DAG may track all or selected interdependencies identified in the dependency information. In one example implementation, dependency information is checked for correctness, that is, it may be validated to ensure it references objects, modules and/or applications that exist, that it complies with semantic and/or syntactic rules if any, and the like. As noted the DAG may track all interdependency relationships, but each relation may have one or more associated label to facilitate filtering the DAG into a subgraph satisfying one or more filter.

In one example implementation, after the graph generator 106 determines the DAG, a deployable module subgraph generator 108 may determine a first subgraph of the interdependency graph identifying the deployable modules. As discussed above, a CI/CD tool identifies modules that have been updated, and the CI builds, e.g., compiles, links, interprets, converts, performs tasks needed to attempt to create a deployable module. A module may fail testing and the CI will be unable to create a deployable module. This represents an error condition that may be reported, such as to the application developer, the module developer, to a messaging platform such as the Slack messaging platform or other platform, etc. After updated modules are successfully tested their status may be tracked to indicate they are deployable. In one example implementation, the DAG tracks the module and a label or other characteristic is associated with a module to indicate it is deployable. In another example implementation, the DAG only contains modules that have successfully passed CI testing. It will be appreciated deployment of an application requires all modules relevant to a desired deployment be known to be deployable. In one example implementation, the AppMeta Registry interacts with the CI/CD tools to keep its data, such as the DAG, up to date. One skilled in the art will appreciate CI/CD tools and the registry will provide interfaces, tools, APIs, etc. to enable the different tools/environments to communicate. In one example implementation the CD tool requests a graph from the AppMeta Registry and passes labels to a filter to identify modules of interest, such as modules that are labeled or otherwise indicated as ready for deployment.

In one example implementation, after the subgraph generator 108 determines the graph of deployable modules, a targeted module subgraph generator 110 may determine a second subgraph of the first subgraph identifying modules associated with a deployment target, e.g., AWS, Azure, etc. As discussed above there may be modules that should or should not be used depending on the desired target. For example, there may be modules specifically written for different brands of phones or other portable electronics, and other modules written specifically for different types of computers, or consumer devices, virtual machines or other environments as the case may be. There may also be modules that duplicate functionality in one cloud platform, but that functionality is not present in another cloud platform, and hence one would not typically deploy the duplicative functionality.

However, there are circumstances where one may want to override the platform with a module providing duplicative functionality if there was need to update the cloud platform. For example, if the platform had an issue needing correction, such as an incorrect implementation of network transport layer security (TLS), an overriding module may be deployed to provide updated encryption technology until the cloud platform issue was resolved. Therefore, based on the desired target and other such deployment issues and/or considerations, the second subgraph may be determined. In one example implementation, as noted above, the CD may pass labels to a filter to identify modules of interest, such as modules relevant to a desired target. It will be appreciated Kubernetes, as well as other environments, support this use of labels.

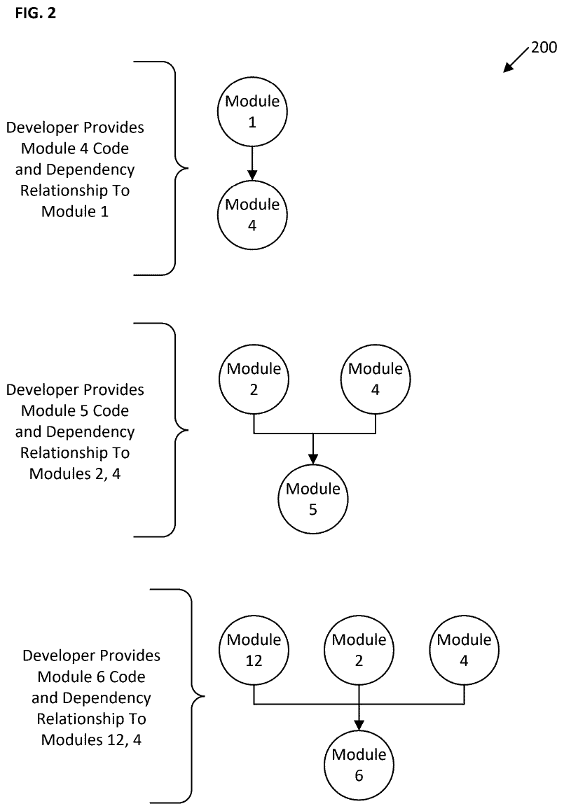

In one example implementation, after the subgraph generator 110 generates the second subgraph of targeted modules, a graph ranker 112 may rank the modules of the second subgraph. It will be appreciated that since module developers may be independent of each other, they may only have a limited perspective of their contribution to an application being deployed. Thus, for example, we can assume a module developer might only know the modules, data, resources, etc. required to properly build or otherwise instantiate that developer's module. If we assume modules are numbered 1. . . n where there are n modules in an application, the CI will identify, for example, that modules 4, 5 and 6 have been updated. The developers of these modules may have indicated that module 4 depends on module 1, module 5 on modules 2 and 4, and module 6 depends on modules 2, 4, and 12. FIG. 2 illustrates, according to one example implementation, a directed acyclic graph 200. Illustrated are exemplary DAG sections corresponding to the dependencies for modules 4, 5, and 6.

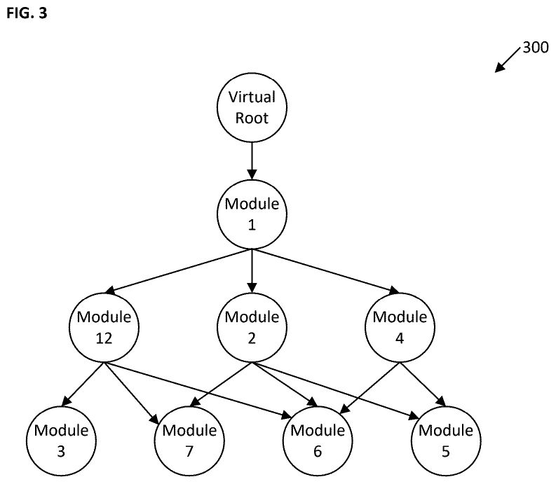

The graph ranker/related generators 106-110 may query the AppMeta Registry as discussed above to generate a targeted subgraph by generator 110 to determine a graph taken from the global DAG for all modules that is the graph including all deployable updated modules, i.e., modules 4, 5 and 6, as well as all of the intervening dependencies between these modules and the root of the DAG. While shown separately, it will be appreciated graph generators 108, 110 may be a functionality provided by graph generator 106. FIG. 3 illustrates, according to one example implementation, a directed acyclic graph 300. Illustrated is an exemplary subgraph indicating interdependencies indicated by developers. And shown, module 4 depends on module 1 which depends on nothing since as shown it only depends on a virtual root of the graph. However, module 5 dependencies include modules 2 depending on module 1 and module 4 depending on module 1. The overall goal is to rank the order of module deployment to ensure all preceding modules on which a module depends are deployed before deploying a module that depends on that preceding module. And, as will be appreciated, dependencies may be on already deployed modules where it is simply necessary to ensure their availability, as well as they may depend on modules CI identified as updated and hence one updated module needs to be properly deployable, e.g., by the CI/CD tools, before another updated module depending on it may also be properly deployed.

So, for example, we cannot deploy module 5 before module 4 since it depends on it, but we could deploy modules 5 and 6 contemporaneously since they both depend on module 4 and other already-deployed modules so they are independent of each other. Once module 4 is deployed we can deploy modules 5 and 6 in whatever order is convenient. To track deployment order, a ranking system may be employed. In one example implementation, module 4 would be given a Rank 1 as it is highest up (closest to the root) in the DAG needing deployment, and once deployed other updated modules lower in the DAG may then be deployed. For example, as shown in FIG. 3, modules 5 and 6 both depend from module 4 (as well as other modules) and would both be given Rank 2 since they depend on module 4 but are otherwise independent of each other. The ranking tracks that it is necessary to deploy module 4 first then modules 5 and 6. And so on for other modules being updated, their location/depth in the DAG will indicate the order in which they may be deployed. In one example implementation, modules are represented by nodes in a graph. As discussed above a DAG may be used to track all modules in an application and interdependencies between them. In the DAG there will be some number of paths descending from the root based on the number of first level nodes that only depend from the root. FIG. 3 shows 1 path off module 1 that breaks into 3 sub-paths, and so on. Using module numbers as path references, we see in FIG. 3 paths 1-12-3, 1-12-7, 1-2-6, 1-4-5. For the updated modules 4, 5, and 6, module 4 has a shorter path and is assigned a higher ranking than updated modules with longer paths.

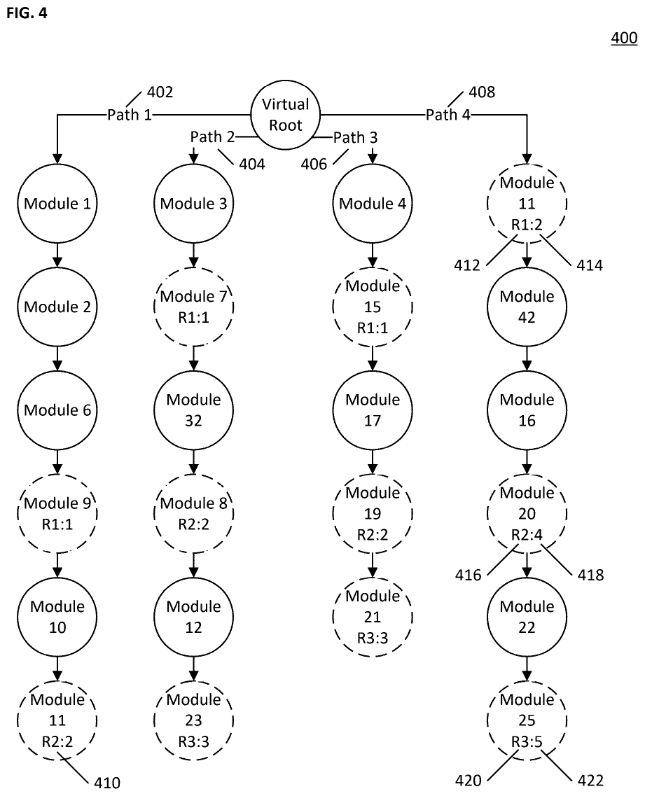

Let's consider a more complicated example. FIG. 4 shows a larger graph 400 of modules determined based at least in part on developer-indicated dependencies, and in this example, modules 9, 11, 7, 8, 23, 15, 19, 21, 20 and 25 have been updated and need to be ranked for deployment to ensure preceding base modules on which later modules depend are deployed before the later modules are deployed. As shown, the graph is a DAG indicating all modules determined by the targeted module subgraph generator 110, where solid lines represent previously deployed modules 1, 2, 6, 10, 3, 32, 12, 4, 17, 42, 16, 22 that have not been updated, and where dashed lines represent modules 9, 11, 7, 8, 23, 15, 19, 21, 20 and 25 have been updated. In this example implementation, a first operation may be to identify all paths in the graph 400, giving labeled Path 1 402, Path 2 404, Path 3 406 and Path 4 408. We may then calculate ranks for the updated modules, so for Path 1, modules 9 and 11 are respectively ranked 1 and 2 where module 9 is raked first since it is higher up in its path than module 11. For Path 2, modules 7, 8, and 23 are respective ranked 1, 2, and 3. For Path 3, modules 15, 19 and 21 are ranked 1, 2 and 3 respectively. And for Path 4, modules 11, 20, and 25 are ranked 1, 2 and 3 respectively.

However, the ranking in different paths need to be updated so that each updated module is assigned its maximum depth across multiple different paths to ensure later dependencies always have a larger ranking so they deploy after preceding dependencies. So, let's consider the module paths of each Path 402-408. Path 1 has module path root-1-2-6-9-10-11. Path 2 has module path root-3-7-32-8-12-23. Path 3 has module path root-4-15-17-19-21. Path 4 has module path root-11-42-16-20-22-25. In one example implementation, a check is made for duplicate modules, e.g., modules appearing in multiple paths. If there are duplicates, e.g., both Path 1 and Path 4 contain module 11, where it is at the end of Path 1 but heading Path 4, this would make module 11 rank 1 in path 4 considering the path alone, but we would adjust its rank to have a ranking of at least 2 to ensure module 9, which is ranked 1 in path 1, is sure to be deployed prior to module 11 even though module 11 is ranked 1 in path 4. Conceptually, the idea is to ensure deployment order so when module 11 is determined duplicative in different paths, its highest ranking 2 410 is copied to duplicates so they are not inadvertently deployed too early.

Thus, as shown, in Path 4 408, module 11 would have an initial ranking 412 of 1 but it would be updated to a final ranking 414 of 2 since that is the highest rank 410 in the graph 400. Note a “Rx:y” notation is used for a module, meaning the module had an initial ranking of x and a final ranking of y, where y may change based on a ranking analysis discussed below. Then, since module 11 in Path 4 now ranks at 2, the updated modules 20, 25 need their ranks adjusted. In one example implementation we would just add their current rank to the max ranking of module 11, so module 20 has an initial rank 416 of 2 which now becomes a final rank 418 of 4, and module 25 has an initial rank 420 of 3 which now becomes a final rank 422 of 5.

Conceptually, the idea is to apply a numbering scheme so that the highest rank for a module is assigned to the lowest rank duplicate graph node for that module, and all updated nodes in a path depending from the duplicate module have their ranks increased so they do not get deployed until the prior module, e.g., module 11, is deployed. When there are multiple duplicate modules, each path is searched again for the duplicate nodes for the module and as discussed above, the highest rank discovered in the DAG is assigned to the lower ranked nodes for the duplicate modules, and the dependencies in that path are adjusted to have higher ranks than the propagated value for the duplicate module. It will be appreciated by one skilled in graph manipulation that such adjustments are propagated through the DAG for all duplicate modules to cascade reranking as necessary in the DAG. Many different ranking value techniques may be employed so long as the basic constraint holds where duplicate modules are readjusted to start with their highest rank elsewhere in the DAG to ensure their deployment does not occur too soon. For example, if module 11 were deployed first based on its Path 4 rank 1, its deployment would be invalid since it depends on Path 1 rank 1 module 9 which needs to deploy before deploying module 11.

After traversing paths 1-4 402-408, identifying duplicate modules (duplicate graph nodes), and reranking the modules to ensure proper ranking, we have multiple modules identified for multiple ranks. In the FIG. 4 example implementation, modules 9, 7, 15 are ranked 1; modules 11, 8, and 19 are ranked 2; module 23 is ranked 3, module 20 is ranked 4, and module 25 is ranked 5. In an alternate example implementation, not illustrated, some optimization may be performed to reduce rank values. For example, the final rank for module 20 was determined by adding its initial rank of 2 to the propagated final rank of 2 for base module 11, giving it a rank of 4. In this alternate example implementation, it could have simply been incremented by 1, in which case it would have joined modules ranked 3. Once the graph ranker 112 has ranked all modules in the DAG, they may be deployed.

A rank-based deployer 114 may be used to deploy the modules of the second subgraph based at least in part on the ranking. As will be appreciated there are many different ways to deploy the modules and the details will depend, for example, on the CI and/or CD employed. In one example implementation, the graph ranker 112 and deployer 114 may use tools such as Kubernetes and ArgoCD. After determining the final ranking of nodes, a deployer would deploy all Rank 1 modules, then Rank 2, etc. Since all modules in a particular ranking are independent of each other, it will be appreciated the deployer may elect to deploy them randomly or based on various considerations, such as cost, resource requirements, time, data-access restrictions, module volatility, service level agreement (SLA), etc. For example, one module may require access to external data to be deployed and the deployer may elect to delay deploying that module based on considerations associated with accessing the external data. A trivial example would be if cost to access the data were about to decrease at a later time, the deployer could elect to deploy other same-ranked modules in an effort to optimize costs.

In one example implementation, there are no special considerations to suggest internally ranking the modules of a particular rank. Thus, the rank-based deployer performs the deployment of all updated modules having Rank 1 however it may elect to do so, then deploys all modules of Rank 2, etc. until all module deployments have been performed.

FIG. 1B illustrates an exemplary method 116 in accordance with the FIG. 1A example implementation to deploy an application and/or associated data in accordance with various example implementations.

As discussed above, when an application contains multiple modules, e.g., code for microservices, associated data, metadata and/or other data, content, networked resources, etc., it becomes increasingly complex to deploy modules in an order that satisfies dependencies that may exist between multiply-update modules. It will be appreciated the illustrated implementation may be broken down into further detailed operations, or presented as different operations, but ultimately the operations are to perform as discussed above to identify updated modules, filter modules with respect to a deployment target if any, rank modules deployable modules to satisfy deployment constraints, such as interdependencies, and to deploy them accordingly.

As illustrated a first operation, is determine 118 an interdependency graph corresponding to at least modules for an application. In one example implementation the graph may be based at least in part on any number of known graphing environments, such as the GraphDB platform. As discussed above, developers may have limited insight into the context in which their module is used, but they will at least be aware of dependencies for their module. These dependencies may be identified in the code or other data associated with their module. And when a query is made for a DAG representing those dependencies, such as will occur in various implementations using CI/CD tools, the interdependency graph is determined and stored 120 in a registry artifact such as the AppMeta Registry. Apart from developer identified dependencies, the registry may also store labels that may be associated with modules to identify other applications for which the module may be used, other modules with which the module may be deployed with to cooperatively perform a task, as well as identify a target deployment environment, AWS, Azure, etc. It will be appreciated in one exemplary implementation, labels/tags and/or other data/metadata associated with a module may be incorporated into a node's data structure in a DAG; such associated data facilitates filtering nodes (such as for a specific target environment), traversing the DAG, and ranking modules.

After storing 120 the graph, as illustrated a next operation may be to determine 122 a deployable module subgraph of the interdependency graph. In some exemplary implementations, the term ‘deployable’ may include whether a module successfully passed CI/CD testing of updates made to the module. It will be appreciated a subgraph may be a separate data structure stored, for example, in the AppMeta Registry, or it may remain a virtual construct mapped against the determined 118 interdependency graph. All modules that have been successfully tested are deemed deployable. Note multiple modules may be updated and if a necessary module was updated but failed testing, this may block deployment of some other updated modules depending on it.

After determining 122 the deployable modules subgraph, as illustrated a next operation may be to determine 124 a targeted module subgraph. As discussed above, deployable modules may have associated labels for filtering them against criteria of interest, including deployment target environments. Based on associated filtering labels, the targeted module subgraph may be determined, and if desired, stored in a registry such as the AppMeta Registry as a separate stored graph, or as a data structure mapping against a larger graph (or graphs).

As illustrated, the targeted module subgraph may then be ranked 126 to determine a deployment order that allows deployment satisfying dependencies, see, e.g., FIGS. 2-4. In various example implementations, a graph ranker may rank modules 1. . . n of an application, and it will be appreciated the ranking may be with respect to an entire graph of modules for an application, or only a subset of modules such as in the deployment process, see, e.g., the FIG. 4 related discussion. The graph ranker may query the AppMeta Registry as discussed above to retrieve the generated 124 targeted subgraph (see also FIG. 1A generator 112 and FIG. 4 discussion) to determine a ranked graph of all deployable modules satisfying deployment filtering criteria.

Conceptually, the idea is to apply a ranking numbering scheme so the highest rank for a module is assigned to the lowest rank duplicate graph node for that module. That is, if a DAG has duplicate module references in different paths (represented by graph nodes), such as shown in FIG. 4 for module 11, and in one path a module has a ranking of 5, and in another path it has a ranking of 2 (these are arbitrary rankings for this discussion and are unrelated to the figures), then we know the module cannot be deployed with other rank two modules since that would be too soon for it when it has dependencies ranked 3 and 4 on a different path. Deploying at rank 2 would not allow it to deploy after deployment of the dependencies. It will be appreciated depending on the graph format, e.g., the graph structure shown in FIG. 4 is just one possible DAG format, different ranking numbering and/or schemes may be employed so long as the basic ordering of deployable module deployments is satisfied. In some example implementations, an error condition may be thrown/identified if an update to a module makes it impossible to deploy, such as circular graph references. For example, if a developer of module 10 updates it and indicates a dependency on module 20 and a developer of module 20 updates it and indicates a dependence on module 10, this is a circular situation which causes each module to block the other and render undeployable both modules and any that depend from them. In an example implementation, ranking 126 includes removing from the determined 124 target module subgraph modules causing errors such as exemplary modules 10, 20.

As illustrated, the ranked 126 modules may be deployed 128 based at least in part on the ranking. As discussed above, there are many different ways to deploy the modules, and the details will depend, for example, on the CI and/or CD employed. After ranking, a deployer would deploy all Rank 1 modules, then Rank 2, etc. Since all modules in a particular ranking are independent of each other, it will be appreciated the deployer may elect to deploy them randomly or based on various considerations, such as cost, resource requirements, time, data-access restrictions, module volatility, service level agreement (SLA), etc. If there are no special considerations to suggest internally ranking the modules of a particular rank, the rank-based deployer performs deployment of all updated modules having Rank 1 however it may elect to do so, then deploys all modules of Rank 2, etc. until all module deployments have been performed.

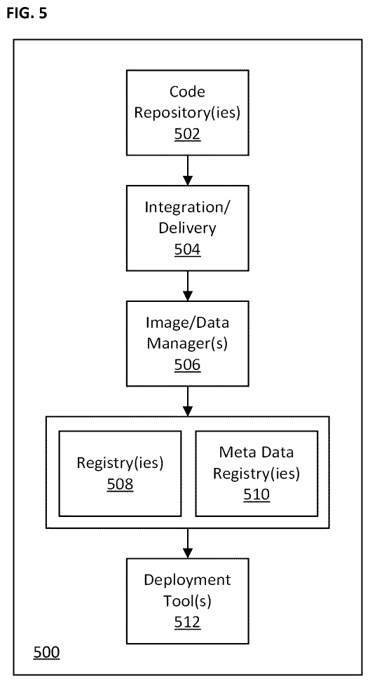

FIG. 5 illustrates an exemplary cloud-based system 500 for deploying an application and/or associated data in accordance with various example implementations. As illustrated there may be a code repository 502, such as may be associated with a Docker, Git, GitLab, or other development discussed above. There may be various files and other data associated with an application, such as Docker files, YAML files, developer code, e.g., the source code for modules in an application, and there may be other data associated with a module, such as application and/or module dependency information, and/or other meta data. The Docker or equivalent data, developer code and associated data may be stored in the code repository. It will be appreciated one or more of any storage environment or repository system may be used.

An integration/delivery tool 504, such as a CI or combined CI/CD tool, may be used to monitor for changes to developer code stored in the repository, as well as to monitor for other updates of interest for which the CI is tasked. In various example implementations, CI may be used to identify a module, e.g., a microservice and/or associated data, was created or updated by a developer, and is tasked with building, compiling, linking, etc. updated code as needed. The CI, as one skilled in the art understands, will test updated code to validate it is performing correctly.

An image/data manager 506 may store artifacts created from the CI tool. For example, CI processing of the Docker file, YAML file and developer code may created one or more of container images that may be published to a container registry 508 such as DockerHub. It will be appreciated DockerHub is provided as one well known example of a registry for storing at least a container image, but other public and/or private registries may be used. As discussed above, Kubernetes artifacts, e.g., Helm artifacts may be used and stored in the registry. Artifactory/registries may store module artifacts, e.g., microservice artifacts, such as container image and YAML files after the build for every code change, along with versioning. Modules may be deployed into Development or Testing environments to put them through different phases of validation cycles. Once validations are successful, a specific version of artifacts (container image and YAML files such as K8s YAMLs) are marked/pinned in the Artifactory/registries as deployable.

An application metadata artifact may be generated for developer code and other data associated with the code, including but not limited to the developer identified dependencies to be pushed to a meta data registry 510 such as the AppMeta Registry artifactory discussed above. The meta data registry stores the graphs/DAGs discussed above with respect to FIGS. 2-4, and stores meta-data to coordinate deployments across different targets. The meta data registry interacts with CI/CD tools to establish a DAG for a deployable application which may be targeted or filtered, and facilitate its deployment based at least in part on dependency data associated DAG for that deployable application.

In one example implementation, a deployment tool 512, such as a CD tool, may be invoked by the meta data registry to trigger deployment of some or all of the updated module code, such as for microservices. In another example implementation, the CD tool coordinates communication with the meta data registry and queries it for DAGs and other data and performs a coordinated deployment to satisfy dependencies between the updated modules. It will be appreciated deployment may be a relative term based on what is being updated, e.g., code is recompiled, files moved, data integrated, etc. Deployment may target a particular destination, e.g., the AWS cloud environment, and this may mean only some of the deployable modules are deployed for that target. For example, AWS and a module may provide the same functionality, so if the target for deployment is AWS, then deployment skips the duplicated functionality unless there is an intent to replace that AWS functionality. In one example implementation, multiple modules, if considered in the aggregate, may provide a function of the target environment, and the multiple modules may be skipped even if individual module does not perform an overlapping function of the target environment. As discussed with respect to FIG. 1, the CD tool accesses the appropriate DAG for the current deployment, obtains the ranking of the updated modules, and deploys each module in each Rank 1 . . . n for n rankings of updated modules.

FIG. 6 illustrates an exemplary computer device 600, in accordance with various example implementations, that may implement and/or support aspects, features, functionality and/or processing of the apparatuses and/or methods described herein for FIGS. 1-5. As shown, computer device 600 (which may be any kind of computing device) may include a number of components, such as one or more processor(s) 602 (one shown) and at least one communication chip(s) 604. In various example implementations, the one or more processor(s) each may include one or more processor cores. It will be appreciated while the term core is used here, other terms may be used such as processing unit(s), execution unit(s) or the like. In various example implementations, the at least one communication chip may be physically and electrically coupled to the one or more processor(s). In further implementations, the communication chip(s) may be part of the one or more processor(s). In various example implementations, computer device 600 may include printed circuit board (PCB) 606. For these example implementations, the one or more processor(s) and communication chip(s) may be disposed thereon. In alternate example implementations, the various components may be coupled without the employment of PCB 606.

Depending on its applications, computer device 600 may include other components that may or may not be physically and electrically coupled to the PCB 606. These other components include, but are not limited to, memory controller 608, volatile memory (e.g., dynamic random access memory (DRAM) 610), non-volatile memory such as read only memory (ROM) 612, flash memory 614, storage device 616 (e.g., a hard-disk drive (HDD)), an I/O controller 618, a digital signal processor 620, a crypto processor 622, a graphics processor 624 (e.g., a graphics processing unit (GPU) or other circuitry for performing graphics, virtual reality (VR) and/or augmented reality (AR)), one or more antenna 626, a display which may be or work in conjunction with a touch screen display 628, a touch screen controller 630, a battery 632, one or more codec(s) 634, e.g., an audio codec, a video codec, a bus management codec, OS policy manager codec, etc., a positioning system such as a global positioning system (GPS) device 636 (it will be appreciated other location technology may be used, including location services provided by software operating within computer device 600 and/or in combination with location estimation services), a compass 638, a motion/movement detector 640, e.g., an accelerometer and/or other devices to detect and/or interpolate motion in one or more axes, real and/or relative movement through space, etc., a gyroscope 642, a speaker 644, a camera 646, a Light Detecting and Ranging (LIDAR) sensor (or other sensing/range detecting and/or measuring technology) 648 and other mass storage devices (such as hard disk drive, a solid state drive, compact disk (CD), digital versatile disk (DVD)) (not shown), and so forth.

As used herein, the term “circuitry” or “circuit” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, processor, microprocessor, programmable gate array (PGA), field programmable gate array (FPGA), digital signal processor (DSP) and/or other suitable components that provide the described functionality. Note while this disclosure may refer to a processor in the singular, this is for expository convenience only, and one skilled in the art will appreciate multiple processors, processors with multiple cores, virtual processors, etc., may be employed to perform the disclosed example implementations.

In some example implementations, the one or more processor(s) 602, flash memory 614, and/or storage device 616 may include associated firmware (not shown) storing programming instructions configured to enable computer device 600, in response to execution of the programming instructions by one or more processor(s), to practice all or selected aspects of the methods described herein. In various example implementations, these aspects may additionally be or alternatively be implemented using hardware separate from the one or more processor(s), flash memory, or storage device(s). In one example implementation, memory, such as flash memory or other memory in the computer device, is or may include a memory device that is a block or byte addressable memory device, such as those based on NAND, NOR, Phase Change Memory (PCM), nanowire memory, and other technologies including future generation nonvolatile devices, or a combination of any of the above, or other memory. The memory device may refer to the die itself and/or to a packaged memory product.

In various example implementations, one or more components of the computer device 600 may implement an example implementation of the FIG. 1 elements 102-114. Thus, for example the one or more processor(s) 602 could be the FIG. 1 processor 102 to implement the FIG. 1 system that may communicate with storage 616 as well as other system components. In some example implementations, I/O controller 618 may interface with one or more external devices to receive a data, such as over a wired and/or wireless bus, including the Universal Serial Bus. Additionally, or alternatively, the external devices may be used to receive a data signal transmitted between components of the computer device 600.

The communication chip(s) 604 may enable wired and/or wireless communications for the transfer of data to and from the computer device 600. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some example implementations they might not. The communication chip(s) may implement any of a number of wireless standards or protocols, including but not limited to mobile broadband (e.g., cellular-based data communication including the following exemplary non-exhaustive list such as IEEE 802.16, IEEE 802.20, Long Term Evolution (LTE/LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Mobile WiMAX, Digital Enhanced Cordless Telecommunications (DECT)), Bluetooth, derivatives thereof, as well as any other wireless protocols that are designated as providing and/or supporting 3G/4G/5G/XG and beyond. The computer device may include a plurality of communication chips 604. For instance, a first communication chip(s) may be dedicated to shorter range standard or proprietary wireless communications such as Wi-Fi and Bluetooth, and a second communication chip 604 may be dedicated to longer range wireless communications such as GPS, WiMAX, LTE, Ev-DO, and others.

The communication chip(s) may implement any number of standards, protocols, and/or technologies datacenters typically use, such as networking technology providing high-speed low latency communication. For example, the communication chip(s) may support RoCE (Remote Direct Memory Access (RDMA) over Converged Ethernet), which is a routable protocol having efficient data transfers across a network, and is discussed for example at Internet URL RDMAconsortium.com. The chip(s) may support Fibre Channel over Ethernet (FCoE), iWARP, or other high-speed communication technology, see for example the OpenFabrics Enterprise Distribution (OFED™) documentation available at Internet URL OpenFabrics.org. It will be appreciated datacenter environments benefit from highly efficient networks, storage connectivity and scalability, e.g., Storage Area Networks (SANs), parallel computing using RDMA, Internet Wide Area Remote Protocol (iWARP), InfiniBand Architecture (IBA), Omni-Path Architecture (OPA) and other such technology. Computer device 600 may support any of the infrastructures, protocols and technology identified here, and since new high-speed technology is always being implemented, it will be appreciated by one skilled in the art that the computer device is expected to support equivalents currently known or technology implemented in future.

In various implementations, the computer device 600 may be any device implementing automated module deployment in accord with module interdependencies, such as a laptop, a netbook, a notebook, a smartphone, a computer tablet, a personal digital assistant (PDA), an ultra-mobile PC, a mobile phone, a desktop computer, a server, cloud environment, cloud storage, a printer, a scanner, a monitor, a set-top box, an entertainment control unit (e.g., a gaming console, automotive entertainment unit, etc.), a digital camera, an appliance, a portable music player, or a digital video recorder, or a transportation device. It will be appreciated computer device 600 is intended to be any electronic device that processes data.

Although above it is noted the computer device 600 may use the one or more processor(s) 602 to implement the FIG. 1 example implementation, it will be appreciated the computing device may include one or more custom logic, circuitry, chips, etc. such as a system on a chip (SOC), to perform in hardware features and/or functions of the illustrated example implementations. For example, as shown, there may be graph generator support logic 650 that may be configured to perform some or all of the operations described above for FIG. 1 generators 106-110. That is, the entirety of the functionality may be implemented, or only a desired subset of functionality may be offloaded for hardware performance benefits for some operations while other operations occur in combination with software that may be accessed from, for example, storage device 616 or over a network and/or the Internet by way of, for example, communication chip 604 or antenna 626. Similarly, there may be graph ranker support logic 652 that may be configured to perform some or all of the operations described above for FIG. 1 graph ranker 112.

FIG. 7 illustrates an exemplary computer-readable storage medium 700. The storage medium may be transitory, non-transitory or a combination of transitory and non-transitory media, and the medium may be suitable for use to store instructions that cause an apparatus, machine or other device, in response to execution of the instructions by the apparatus, to practice selected aspects of the present disclosure. As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium.

As shown, non-transitory computer-readable storage medium 702 may include a number of programming instructions 704. Programming instructions 704 may be configured to enable a device, e.g., computer device 700, in response to execution of the programming instructions, to implement (aspects of), for example, the FIG. 1 system. In alternate example implementations, programming instructions 704 may be disposed on multiple computer-readable non-transitory storage media 702 instead. In still other example implementations, programming instructions 704 may be disposed on computer-readable transitory storage media 702, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). Cooperative program execution may be for a fee based on a commercial transaction, such as a negotiated rate (offer/accept) arrangement, established and/or customary rates, and may include micropayments between device(s) cooperatively executing the program or storing and/or managing associated data.

The present disclosure is described with reference to flowchart illustrations and/or block diagrams of methods, apparatus (systems) and computer program products according to example implementations of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct and/or coordinate operation of one or more computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications, implementations, or equivalents.

What is claimed is:

1. A computer system, comprising:
one or more processors; and
one or more non-transitory computer-readable storage media storing programming for execution by the one or more processors, the programming comprising instructions to:
determine an interdependency graph for one or more modules for an application;
determine a first subgraph of the interdependency graph identifying deployable modules;
determine a second subgraph of the first subgraph identifying modules associated with a deployment target;
rank the modules of the second subgraph; and
deploy the modules of the second subgraph based at least in part on the ranking.

2. The computer system of claim 1, wherein the modules further have an associated microservice.

3. The computer system of claim 1, wherein the programming comprises instructions to determine the interdependency graph based at least in part on a dependency indicator.

4. The computer system of claim 3, wherein the dependency indicator indicates one or more of a required module, a resource, another application, or a data source.

5. The computer system of claim 1, wherein the programming comprises instructions to:
determine the deployable modules according to a continuous integration (CI) process; and
deploy the modules based on the ranking according to a continuous deployment (CD) process.

6. The computer system of claim 5, wherein the programming further comprises instructions to:
store the interdependency graph in a database;
query the database with the deployment target; and
receive from the database the second subgraph including the ranking.

7. A method, comprising:
determining an interdependency graph for one or more modules for an application;
determining a first subgraph of the interdependency graph identifying deployable modules;
determining a second subgraph of the first subgraph identifying modules associated with a deployment target;
ranking the modules of the second subgraph; and
automatically deploying the modules of the second subgraph based at least in part on the ranking.

8. The method of claim 7, wherein the modules further have an associated microservice.

9. The method of claim 7, further comprising:
determining the interdependency graph based at least in part on a dependency indicator.

10. The method of claim 9, wherein the dependency indicator indicates one or more of a required module, a resource, another application, or a data source.

11. The method of claim 7, further comprising:
determining the deployable modules according to a continuous integration (CI) process; and
deploying the modules based on the ranking according to a continuous deployment (CD) process.

12. The method of claim 11, further comprising:
storing the interdependency graph in a database;
querying the database with the deployment target; and
receiving from the database the second subgraph including the ranking.

13. A system, comprising:
a data repository to store data corresponding to modules of an application;
an automated software updater to at least monitor for an update to one or more module of the application;
a graph generator to at least determine an interdependency graph for one or more of the modules of the application, the interdependency graph identifying at least deployable modules associated with a first deployment target;
a database to store at least the interdependency graph; and
a deployment tool to at least query the database to receive a ranked graph determined based at least in part on the identified deployable modules, the ranked graph including a deployment ranking order for the identified deployable modules.

14. The system of claim 13, further comprising:
the deployment tool to at least deploy the deployable modules based at least in part on the deployment ranking order.

15. The system of claim 13, wherein the modules further have an associated microservice.

16. The system of claim 13, wherein modules of the interdependency graph have an associated dependency indicator to indicate one or more of a required module, a resource, another application, or a data source.

17. The system of claim 13, wherein the graph generator determines a second interdependency graph identifying at least deployable modules associated with a second deployment target.

18. The system of claim 13, wherein the graph generator to at least determine deployable modules according to a continuous integration (CI) process.

19. The system of claim 13, wherein the deployment tool to at least deploy the deployable modules with a continuous deployment (CD) process operating with respect to at least the deployment ranking order.

20. The system of claim 13, wherein the deployment tool at least to query the database with the deployment target to receive the ranked graph.
